(19) United States
(12) Patent Application Publication
(10) Pub. No.: US 2008/0291403 A1
(43) Pub. Date: Nov. 27, 2008

(54) IMAGE PROJECTION APPARATUS AND OPERATION METHOD THEREOF

(76) Inventor: Yukihiro KAMETA, Kitakami (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/022,179

(22) Filed: Jan. 30, 2008

(30) Foreign Application Priority Data
May 23, 2007 (JP) 2007-136118

(51) Int. Cl. G03B 21/20

(52) U.S. Cl. 353/84

(57) ABSTRACT

An image projection apparatus controls to vary at least one of current, voltage and power of a discharge lamp for each color segment by means of at least two control signals. When the discharge lamp reaches the stable state after turned on, the discharge lamp exhibits the constant voltage characteristic and an amount of light emitted from the lamp is varied in accordance with current or voltage applied thereto. The light amount of the lamp is varied to at least 3 stages simultaneously in accordance with an image signal in synchronism with color to be emphasized and weakened in each color (e.g. red, blue, green and white).

### INCORPORATION BY REFERENCE

The present application claims priority from Japanese application JP2007-136118 filed on May 23, 2007, the content of which is hereby incorporated by reference into this application.

### BACKGROUND OF THE INVENTION

The present invention relates to an image projection apparatus which projects an image by means of a discharge lamp to display it and an operation method thereof.

The technique concerning an image projection apparatus which projects an image by means of a discharge lamp to display it is described in JP-A-2004-212890 and JP-A-2006-349912, for example.

JP-A-2004-212890 discloses the technique that in an operation method of a projection type system in which light emitted from a high-voltage discharge lamp turned on by DC power successively passes through a plurality of color segments formed by dividing a color filter to project an image on a screen, pulse current is superposed on DC lamp current of the high-voltage discharge lamp in synchronism with at least one particular color segment.

JP-A-2006-349912 discloses, as the technique for improving the picture quality, the technique that a pulse circuit generates a synchronous signal including a plurality of on-off patterns synchronized with the rotational speed of a color filter and an optical element in the projection type system and a current having any one of current intensity selected from the following:

1) first negative pulse,

2) second negative pulse, and

3) no pulse

in accordance with the on-off pattern is superposed on DC current to be applied after a fixed time from the falling time of a red or blue segment, so that the DC current is controlled to be smaller than a regular value during a fixed time of a green segment.

### SUMMARY OF THE INVENTION

In the conventional image projection apparatus, only one on or off control signal is supplied from a control part for controlling an image to a power supply for driving a lamp, so that the picture quality is improved at only the initial setting stage and it is difficult to attain higher gradation.

It is an object of the present invention to provide an image projection apparatus having improved picture quality.

In order to achieve the above object, according to the image projection apparatus of the present invention, at least one of current, voltage and power of a discharge lamp is controlled to be varied for each color segment by means of at least two control signals.

When the discharge lamp reaches the stable state after turned on, the discharge lamp exhibits the constant voltage characteristic and the amount of light emitted from the lamp is varied in accordance with the current or power applied thereto. In the present invention, for example, the amount of light of the lamp is varied to at least 3 stages simultaneously in accordance with an image signal in synchronism with color to be emphasized and weakened in each color (e.g. red, blue, green and white).

According to the present invention, the picture quality of the image projection apparatus can be improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram illustrating an example of an image projection apparatus according to an embodiment of the present invention;

FIG. 2 shows an example of structure of a conventional color filter and timing of a control signal and a lamp current (power);

FIG. 3 is a timing chart showing the relation of a color filter, first and second control signals S1 and S2, and a lamp current (power) generated on the basis of combination of the control signals S1 and S2 according to an embodiment of the present invention;

FIG. 4 shows an example of a timing chart different from that of FIG. 3 in that the second control signal is pulse-width-modulated (PWM) according to another embodiment of the present invention; and

FIG. 5 is a graph showing the relation of the on-off ratio of the PWM signal (pulse width signal ratio) and lamp power (current amount) in the example of FIG. 4.

### DESCRIPTION OF THE EMBODIMENTS

Embodiments of an image projection apparatus and an operation method thereof according to the present invention are now described with reference to the accompanying drawings but the present invention is not limited to the following embodiments.

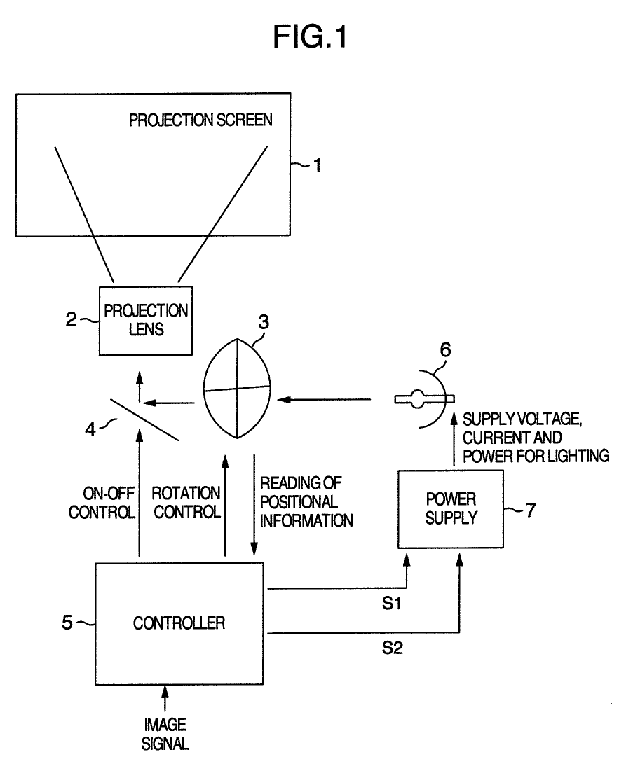

FIG. 1 schematically illustrates an example of an image projection apparatus according to an embodiment of the present invention. The image projection apparatus includes a projection lens 2, a color filter 3, a reflection type device 4, a controller 5, a lamp 6 constituting a light source and a power supply 7 for turning on the lamp. The lamp 6 can use a high-voltage mercury lamp, for example, and light of the lamp 6 is emitted in a predetermined direction by means of a reflector. The power supply 7 is connected to the lamp 6 and supplies voltage, current and power for turning on the lamp 6.

The color filter 3 includes a plurality of dichroic filters having the property of selectively passing visible light and the color filter 3 is divided into four color segments including white (W), red (R), green (G) and blue (B). Moreover, the color filter 3 is formed into a disk and can be rotated by rotation means not shown.

In the embodiment, the color filter 3 is divided into 4 colors of W, R, G and B, although the present invention is not limited thereto and the color filter may be divided into 3 colors of R, G and B or 6 colors including other colors added thereto.

The reflection type device is constituted by a reflection type light modulation device such as a digital mirror device (DMD) and reflects light of each color passing through the color filter 3 toward the projection lens 2. Light of each color passing through the projection lens 2 is projected on a projected body such as a projection screen 1, so that an image is displayed on the projected body.

The controller 5 can make control of turning on and off the reflection type device 4, control of rotation and reading of positional information of the color filter 3 and control of the power supply 7 on the basis of an image signal inputted externally. The controller 5 supplies two control signals S1 and S2 to the power supply 7 on the basis of the inputted image signal. The power supply 7 generates voltage, current and power supplied to the lamp 6 on the basis of the two control signals S1 and S2. Consequently, the amount of light of the lamp 6 is adjusted gradually.

An operation method of the image projection apparatus is now described.

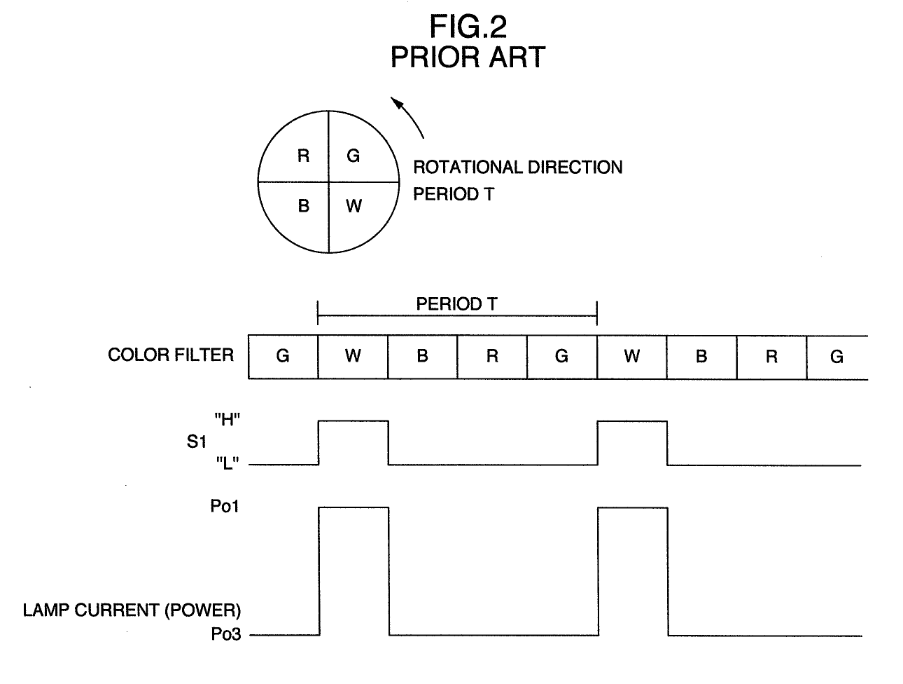

FIG. 2 is a timing chart of a color filter, a control signal and a lamp current (power) in a prior art. Further, FIG. 2 shows an example of structure of the color filter. One period T is constituted by WBRG.

The timing chart of FIG. 2 shows an example of increasing the brightness of an image and the control signal S1 is controlled to be changed from L to H in synchronism with the timing of white (W) of the color filter. Consequently, the lamp current (power) rises from Po3 to Po1 at the timing of white, so that the whole image can be made lighter. In such operation method, however, the image can be adjusted at only two gradations and cannot be displayed with higher gradation.

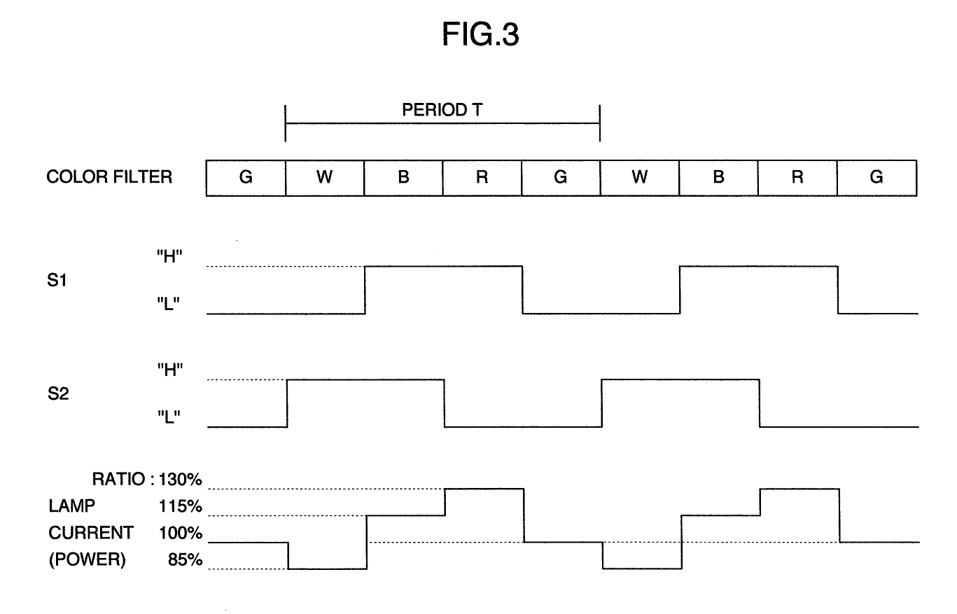

FIG. 3 shows an embodiment of the operation method according to the present invention. FIG. 3 is a timing chart showing the relation of the color filter, the first and second control signals S1 and S2 and the lamp current (power) generated on the basis of combination of the control signals S1 and S2. One period T is constituted by WBRG of the color filter.

The first and second control signals S1 and S2 are turned on and off in synchronism with the on signal of each color. The first control signal S1 is to control the power supply so that current or power supplied to the lamp is increased. The second control signal S2 is to control the power supply so that the current or power supplied to the lamp is reduced.

In the embodiment, when the first control signal S1 is changed from off (L) to on (H), the current or power is set to be increased from 100% to 130%. When the second control signal S2 is changed from off (L) to on (H), the current or power is set to be reduced from 100% to 85%.

The following Table 1 shows ratios of current or power at the time that the first and second control signals S1 and S2 are turned on and off. It is supposed that the reference (100%) is set when the first and second control signals are both off.

TABLE 1
Example of Current or Power Ratios (%) set for Control
Signals S1 and S2

First Control
Signal S1

| | | OFF “L” | ON “H” |
|---|---|---|---|
| Second | OFF “L” | 100 | 130 |
| Control | ON “H” | 85 | 115 |
| Signal S2 | | | |

As understood from Table 1, the first and second control signals are combined to control the power supplied to the lamp to 4 stages. Consequently, the timing of the first and second control signals can be set in accordance with the timing of WRGB of the color filter to control the gradation of each color to 4 stages, so that an image can be displayed with higher gradation.

In the example shown in FIG. 3, the brightness is suppressed and the gradations of blue and red are adjusted to be emphasized. The lamp currents are adjusted to be 85% for W (white), 115% for B (blue), 130% for R (red) and 100% for G (green). The first control signal in this case is set to be H when the color filter is B and R and the second control signal is set to be H when the color filter is W and B.

The ratio of current or power upon turning on and off of the control signal S1 is not limited to the above ratio and may be set to any ratio. In Table 1 described above, the increased ratio of current by the first control signal is set to 130% and the reduced ratio by the second control signal is set to 85% by way of example, although the increased ratio may be set to 150% and the reduced ratio to 75%.

The increased ratio by the first control signal and the reduced ratio by the second control may be identical, although since the gradation cannot be controlled to 3 stages in this case, it is desired that the increased ratio by the first control signal and the reduced ratio by the second control signal are set to be different as the above example and it is desired that the ratio of current or power changes at the same intervals by combination of both the control signals.

The controller 5 can analyze the inputted image signal and judge which of brightness and color gradation is given preference. The controller 5 generates the first and second control signals S1 and S2 supplied to the power supply on the basis of the judgment result. The first and second control signals are combined to adjust the brightness and the color gradation individually, so that the picture quality is improved. Further, the control signals may be set by a user externally.

When the image signal inputted to the image projection apparatus gives preference to the brightness, for example, only the first control signal is used and the on signal is synchronized with the white segment, so that the brightness can be increased. Moreover, when the image signal requiring only adjustment of the color gradation is inputted, the image is whitened when white is emphasized. Accordingly, the first control signal for increasing the lamp current is turned off at the timing of white segment and only the second control signal for reducing the lamp current is turned on. Thus, the brightness of the image is suppressed. The first and second control signals S1 and S2 are selected to be fitted to the color desired to be emphasized in accordance with intensity of desired RGB. Thus, only gradation of each color can be adjusted.

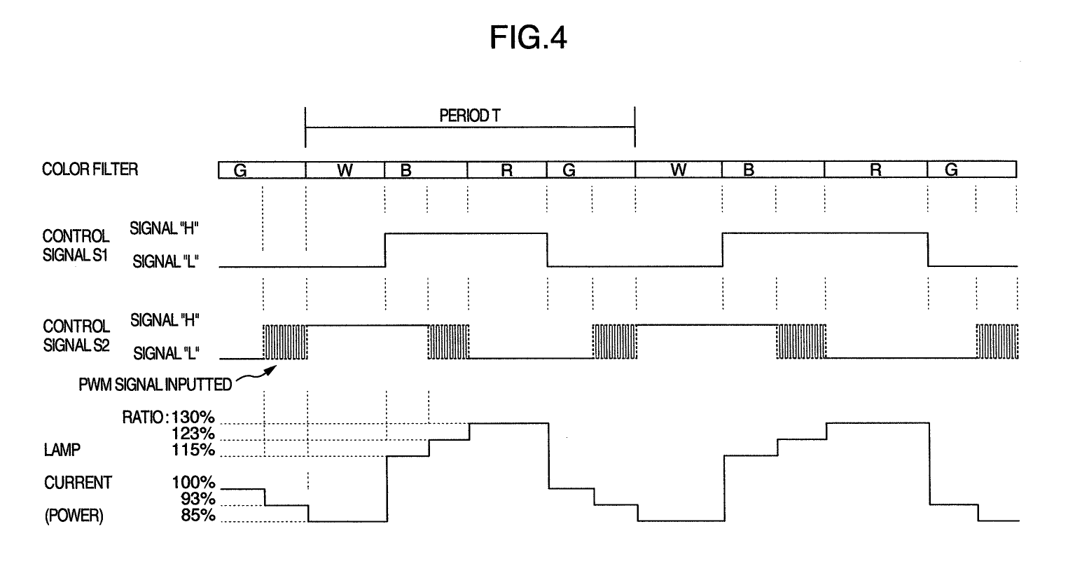

Referring now to FIG. 4, a modification example of the operation method of the image projection apparatus is described. The example shown in FIG. 4 is different from the timing chart shown in FIG. 3 in that the second control signal is pulse-width-modulated (PWM). That is, the on signal of the second control signal is constituted by multiple pulses generated by dividing the original on signal into a plurality of pulses.

In the example shown in FIG. 4, the PWM signal is formed in the second control signal at the timing of the second half of G and the second half of B. The PWM signal has the on-off ratio of 50%. Consequently, the lamp power is set to about 93% at the timing of G and about 123% at the timing of B and is set to be substantially middle of the ratios. Thus, the gradation can be controlled finely.

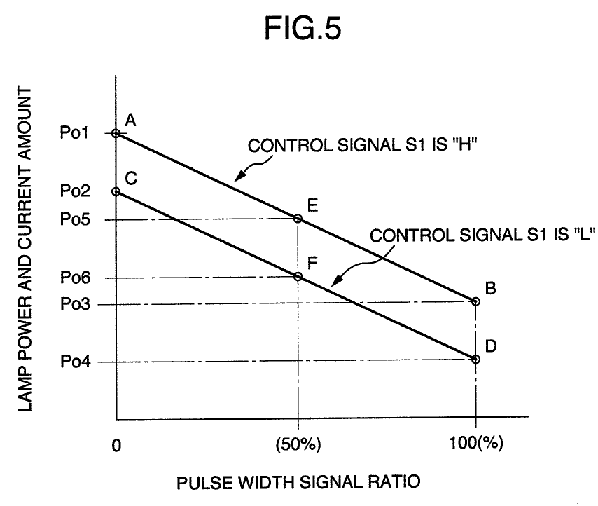

FIG. 5 shows the relation of the on-off ratio (pulse width signal ratio) of the PWM signal of the control signal S2 shown in FIG. 4 and the lamp power (current amount). In FIG. 5, a line connecting points A, E and B represents the relation in case where the control signal S1 is H and a line connecting points C, F and D represents the relation in case where the control signal S1 is L. When the control signal S1 is H, the lamp power (current amount) between Po1 and Po3 can be obtained in accordance with the pulse width ratio of the control signal S2 and when the control signal S1 is L, the lamp power (current amount) between Po2 and Po4 can be obtained in accordance with the pulse width ratio of the control signal S2. That is, it is understood that the on-off ratio of the PWM signal can be varied to change the lamp power finely.

In the embodiment, the on-off ratio of the PWM signal is set to 50%, although the present invention is not limited thereto and it may be set to any value. Further, only the second control signal is constituted by multiple pulses, although the first control signal may be constituted by multiple pulses.

Further, the second control signal at the timing of the predetermined color is subjected to the pulse width modulation, although it may be subjected to modulation using the pulse period.

The reflection type device can switch the projection on the screen of each color at high speed and as the on time of the reflection type device (e.g. DMD) to certain color is longer, that is, as the projection time on the screen is longer, the brightness appears to be increased. In other words, as certain color is projected on the screen for a long time, the color is seen bright. At this time, the on time of the reflection type device is often controlled in a digital manner and accordingly the brightness is increased gradually with the lapse of the on time.

In the embodiment, as described above, since the lamp power is controlled to be varied gradually in synchronism with color by using the first and second control signals or by using the PWM signal, variation of the brightness of the predetermined color is also fined as compared with the case where the lamp power is fixed. Accordingly, variation of the brightness of the predetermined color is made smooth with the lapse of the on time of the reflection type device, so that the reproducibility of the color is improved.

Moreover, the on time of the reflection type device may be controlled more gradually finely in a digital manner instead of controlling to vary the lamp power gradually in synchronism with color. Consequently, since variation of the brightness of color can be made small, variation of the brightness of the predetermined color is made smooth and the reproducibility of the color is improved. In addition, the lamp power can be controlled to be varied gradually in synchronism with color and the on time of the reflection type device can be controlled gradually finely in a digital manner.

The embodiment of the image projection apparatus and the operation method thereof according to the present invention has been described, although the present invention is not limited thereto. In the embodiment, the two first and second control signals have been used, although third and fourth control signals may be added in order to realize fine level gradations.

1. An image projection apparatus comprising:
a lamp;
a power supply connected to the lamp to turn on the lamp;
a color filter of a rotation type having a plurality of substantially uniformly divided color areas which are rotated and to which light flux emitted from the lamp enters; and
a control unit to control the power supply and rotation of the color filter,
wherein an amount of light of the lamp is controlled to at least 3 stages in synchronism with rotation timing of the color filter.

2. An image projection apparatus according to claim 1, wherein
the light amount of the lamp to the plurality of colors is controlled on the basis of an image signal inputted externally.

3. An image projection apparatus according to claim 1, wherein
the control unit supplies to the power supply
a first control signal to increase at least one of current, voltage and power supplied to the lamp in synchronism with timing of the plurality of colors of the color filter and
a second control signal to reduce at least one of current, voltage and power supplied to the lamp in synchronism with timing of the plurality of colors of the color filter.

4. An image projection apparatus according to claim 3, wherein
the first and second control signals are pulse signals.

5. An image projection apparatus according to claim 4, wherein
an on signal of at least one of the first and second control signals is constituted by a plurality of pulse signals and a width or period of the plurality of pulse signals is controlled.

6. An image projection apparatus according to claim 1, wherein
the plurality of colors include white, red, green and blue.

7. An operation method of an image projection apparatus including:
a lamp;
a power supply connected to the lamp to turn on the lamp;
a color filter of a rotation type having a plurality of substantially uniformly divided color areas which are rotated and to which light flux emitted from the lamp enters; and
a control unit to control the power supply and rotation of the color filter;
the method comprising:
controlling an amount of light of the lamp to at least 3 stages in synchronism with rotation timing of the color filter.

8. An operation method of an image projection apparatus according to claim 7, wherein
an image signal is obtained externally and
an amount of light of the lamp to the plurality of colors is controlled on the basis of the image signal.

9. An operation method of an image projection apparatus according to claim 7, wherein
the control unit supplies to the power supply
a first control signal to increase at least one of current, voltage and power supplied to the lamp in synchronism with timing of the plurality of colors of the color filter and
a second control signal to reduce at least one of current, voltage and power supplied to the lamp in synchronism with timing of the plurality of colors of the color filter.

10. An operation method of an image projection apparatus according to claim 9, wherein
the first and second control signals are pulse signals.

11. An operation method of an image projection apparatus according to claim 10, wherein
an on signal of at least one of the first and second control signals is constituted by a plurality of pulse signals and a width or period of the plurality of pulse signals is controlled.

12. An operation method of an image projection apparatus according to claim 7, wherein
the plurality of colors include white, red, green and blue.
